(19) United States
(12) Patent Application Publication
(10) Pub. No.: US 2008/0255939 A1
(43) Pub. Date: Oct. 16, 2008

(54) SYSTEMS AND METHODS FOR ALLOCATING A CONSUMER ACCESS RIGHT TO A LIVE EVENT

(76) Inventors: Richard M. Harmon, Lake Forest, IL (US); Andrew K. Leach, Hinsdale, IL (US)

Correspondence Address: STRATEGIC PATENTS P.C.., C/O PORTFOLIOIP, P.O. BOX 52050, MINNEAPOLIS, MN, 55402, US

(21) Appl. No.: 11/926,081

(22) Filed: Oct. 28, 2007

Related U.S. Application Data
(63) Continuation of application No. 11/609,653, filed on Dec. 12, 2006.
(60) Provisional application No. 60/749,933, filed on Dec. 12, 2005.

(51) Int. Cl. G06Q 30/00

(52) U.S. Cl. 705/14

(57) ABSTRACT

A performer credit program facilitates crediting, tracking, and accumulating performer credits for consumer activity such as purchasing items related to a performer. Consumers manage performer credits in a performer credit account through a performer credit account facility and can elect to convert accumulated credits to access rights that can be used to acquire a ticket to a live event. Performers or their representative can use the information in the accounts to determine interest in and allocate seats for live events. Consumers can acquire, trade, exchange, or sell credits to other consumers on a secondary market allowing consumers to accumulate sufficient credits to convert to an access right. The program encourages consumers to acquire credits to exchange them for access rights that they can either sell or use to acquire a ticket to a live event.

### CROSS-REFERENCE TO RELATED APPLICATIONS

This application claims the benefit of the following provisional application, which is hereby incorporated by reference in its entirety:

Ser. No. 60/749,993 (Method and Apparatus for MP3/Live Event Integration), filed on Dec. 12, 2005 by Harmon et al.

### BACKGROUND

1. Field

The present invention pertains to the fields of event promotion, product sales, seating allocation, and ticket sales, and to associated futures or forward-rights markets.

2. Description of the Related Art

With the advent of digital music and Internet file sharing, consumers have almost unlimited access to music that can be downloaded, including free music downloads. The music industry has embraced the Internet as a distribution channel to deliver content to consumers and has developed purchase-based download sites, most notably Apple Computer, Inc.'s iTunes brand music service (“iTunes”). However, consumers continue to download or share music on a peer-to-peer or free basis. Thus, many of the music products of the recording industry are essentially becoming free to consumers. As a result, there is a continuing need for systems and methods that create an incentive for the music consumer to pay for music, whether it is downloaded from the Internet or purchased in a more traditional venue, such as a bricks-and-mortar retail location. As with the music industry, there is also a need in other industries such as sports, theater, movie, fine arts (e.g.: museums, galleries, and the like), et cetera for systems and methods that creates an incentive for the consumer to purchase authorized merchandise and memberships.

Currently, consumers must often wait for a scheduled ticket sales opening to obtain an access right (e.g., a ticket or pass) to a future live event. This single moment in time when consumers may obtain access rights creates a constricted time window during which potential consumers must frantically call a ticket distributor or log onto a ticket distributor's website, or show up at a ticket sales site or a box office. The processing limitations of the communications medium (e.g., the telephone network or Internet), or the volume of people waiting in line often result in “blockage” of ticket purchase attempts (e.g., busy signals, inability to contact a website, and so on). Thus, the allocation of access to a live event is largely based on luck because the consumers who get through the phone system or access the Internet first receive the most desirable access (e.g., the best venue seats). Additionally, brokers and scalpers may often find ways to circumvent the system to gain access. As a result, the current system of allocating access to a live event is disorderly and frustrating to the consumer, and may prevent an industry from fully recognizing, rewarding, and/or capitalizing on its consumers.

### SUMMARY

Preferred embodiments of the present invention relates to a method and system for allocating an access right to a potential or a scheduled live event based at least in part on a credit amount obtained through activities of a consumer, wherein the activities are associated with a performer of the potential or scheduled live event.

The present invention relates to systems and methods for acquiring an access right to a live event. In an aspect of the invention, systems and method for acquiring an access right to a live event involve accumulating credits through an activity that is associated with a measure of fan loyalty, determining if an amount of accumulated credits surpasses a threshold for conversion to an access right, and converting the credits to an access right to a live event.

The activity may not related to the fan loyalty; may be a consumption activity; may be a purchasing activity; may be a blogging activity; may be a fan-club activity; may be related to fandom; may be an attendance activity; may be a download activity; may be a listening activity; may be an advertisement viewing activity; may be a charitable contribution; may be a known live event; may be a theater event; may be a promotion activity; may be a referral activity; and so on.

The activity may be related to the live event by a group of artists, the live event involving the group of artists. The activity may be related to the live event may a theater production, the live event involving the theater production. The activity may be related to the live event by an artist, the live event involving the artist. The activity may be related to the live event by an event producer, the live event involving the event producer. The activity may be related to the live event by a sponsor, the live event involving the sponsor. The activity may be related to the live event by a venue, the live event involving the venue. The activity may be related to the live event by a location, the live event involving the location. The activity may be related to the live event by a team, the live event involving the team or one or more team members (also known as a participant or a performer). The activity may be related to the event by a league, the live event involving the league. The activity may be related to the live event by a charitable association, the live event involving the charitable association.

The live event may be a prospective live event; may be a future live event; may be a contingent live event; may be a fixed live event; may be a sporting event; may be a music event; and so on.

The access right may be a ticket; an allocation of seats in a venue; a backstage pass; a position of a set; a pass to a party; a pass to a promotional event; an obligation to purchase a ticket at a predetermined price; or the like.

The activity may include at least one purchase of one or more of a CD, apparel, jewelry, decor, gift, stationary, food, beverage, artwork, poster, print, merchandise, memorabilia, book, digital video, DVD, VHS, digital music, digital video, et cetera.

The activity may include at least one purchase of one or more of team branded apparel, league branded apparel, team branded merchandise, league branded merchandise, team branded home decor league branded home decor, team branded furniture, league branded furniture, a team branded automotive accessory, a league branded automotive accessory, a game ball, sports equipment, a hat, a collectible, a baseball cards, sports memorabilia, a video game, a book, a DVD, a VHS, a digital video, and the like.

The activity may include at least one of posting on blogs; posting on message boards; joining a loyalty club; joining a fan club; supporting a performer's cause; posting a performer's link on a social networking site; referring a consumer to purchase a performer's product; referring a consumer to engage in a performer promotional activity; and so on

The systems and methods may further involve trading the access right on a secondary rights market; reverting the access right to credits; accumulating credits as a bonus that is not associated with a measure of fan loyalty; transferring ownership of the credits; trading the credits for other credits that are associated with a different measure of fan loyalty; or the like.

These and other systems, methods, objects, features, and advantages of preferred embodiments of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

Preferred embodiments of the invention and the following detailed description of certain embodiments thereof may be understood by reference to the following drawing in which:

FIG. 1 depicts a market platform for contingent event certificates or rights along with associated participants; and

FIG. 2 depicts a platform for accumulating and redeeming credits for contingent events.

### DETAILED DESCRIPTION

The present invention provides systems and methods for assigning an item to a consumer using an accumulation of points. The consumer accumulates points through an activity that is associated with a measure of fan loyalty. In the preferred embodiment, the activity is associated with an artist or entity that is involved in a future live event. Thus, for examples and without limitation, the activity may involve buying an album from a musician that has or may eventually have future performance dates, buying a video game disc for a game console that will be on sale at a future date, joining a fan club for a band that has or may eventually have future performance dates, and so on.

A system and method for accumulating the points may comprise receiving an indication of the activity from any and all sources (such as and without limitation a point-of-sale system, a fan membership list, a retail receipt, and so forth).

The number of point in a consumer's accumulation may be compared with a threshold. The threshold may be static (e.g. 10,000 points) or dynamic (e.g. 100.sup.th most points of all consumers—the exact number of points that defines the threshold changes as the consumers accumulate points and, in effect, jockey for position). When the consumer's accumulation exceeds the threshold, the consumer may be entitled to convert some or all of his points into an item, access right, contingent event certificate, ticket, seat reservation, seat upgrade, right to buy a product, et cetera that is associated with the future live event. It will be appreciated that preferred embodiments of the present invention provide consumers with both control and transparency with respect to the process of accumulating points and converting points as described hereinabove, throughout this disclosure, and elsewhere.

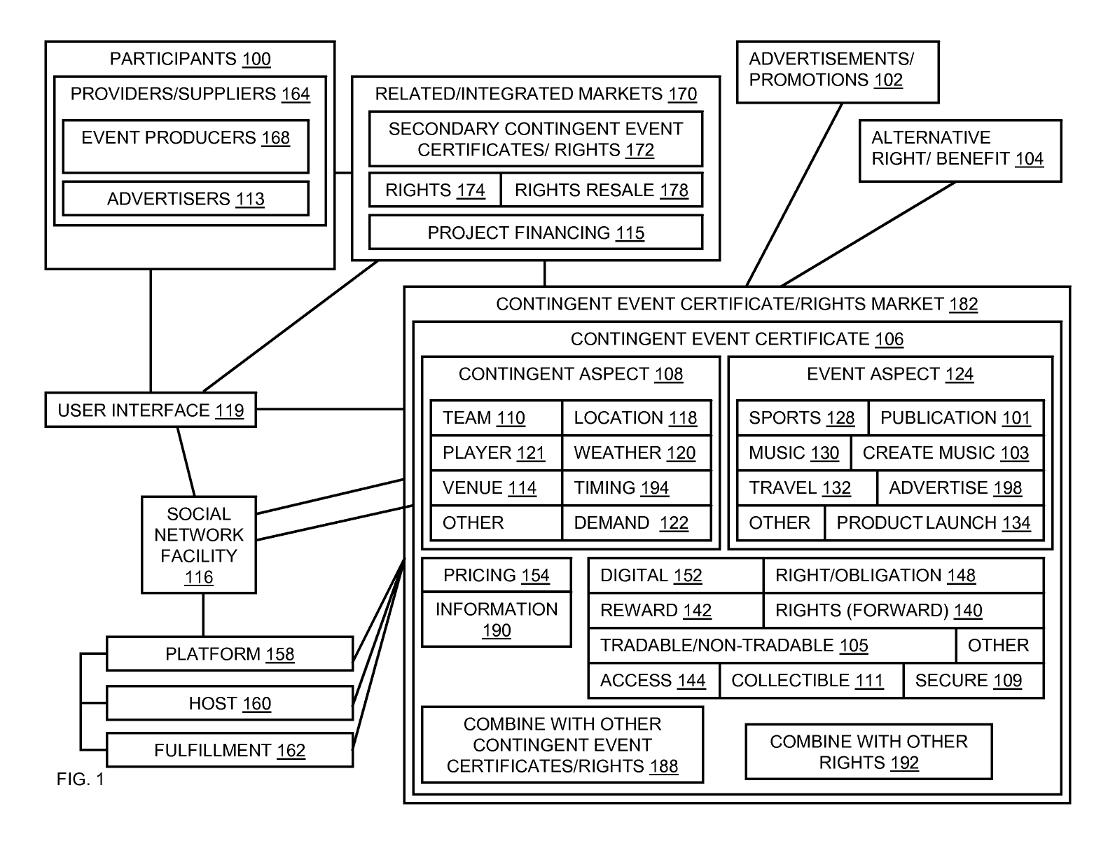

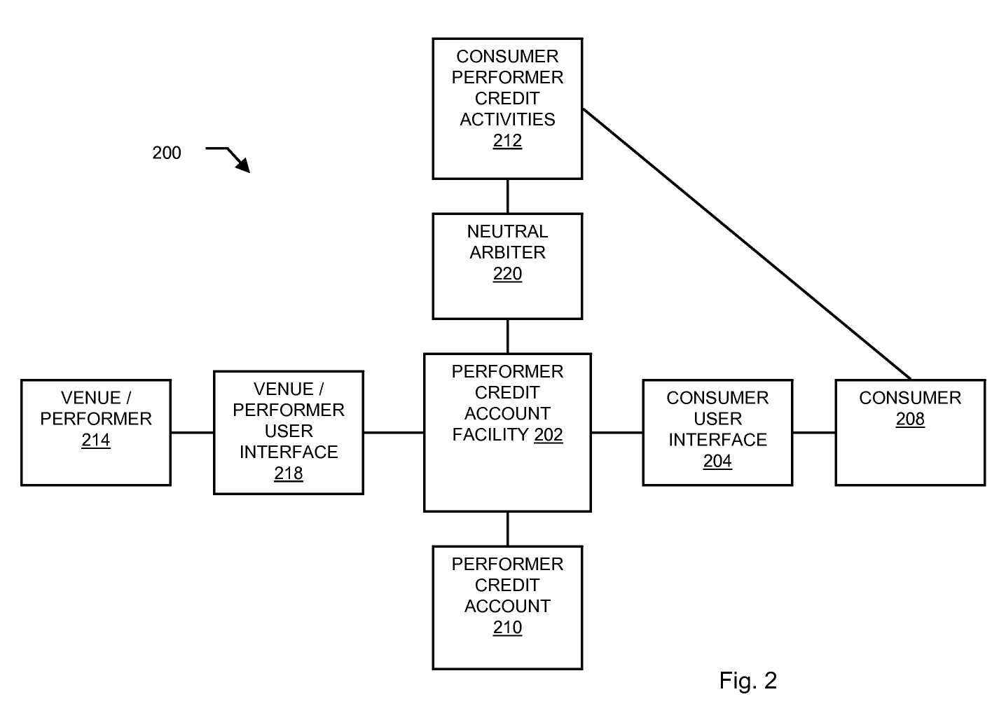

Many aspects of the present invention are described in detail hereinafter with reference to FIG. 2 and still other aspects will be appreciated. All such aspects are within the scope of the present disclosure. Additionally, contingent event certificates and related systems and methods are described in detail hereinafter with reference to FIG. 1. Preferred embodiments of the present invention may or may not employ and/or be associated with contingent event certificates.

Preferred embodiments of the present invention provides improved systems and methods for allocating access to a live event, which may be a contingent event and/or a predefined event. In particular, the systems and methods described herein may allocate access to a live event in a deterministic way that is predominantly based upon an objective measure of a consumer's past behavior and/or activity. Such objective measures may, without limitation, comprise total merchandise purchases by an individual, number of comments posted by an individual to a fan website or blog, an individual's membership in a loyalty or fan club, or any and all other objective measures. For example and without limitation, with preferred embodiments of the present invention it may be possible to sell event tickets primarily to a performer's most dedicated fans (without limitation, as may be objectively measured by the total number of performances attended by each of the fans) as opposed to selling the tickets to the first-to-buy (i.e., in a time-bound fashion) and/or to the first who by chance happen to get through to an overloaded web server or call center (i.e., in a more-or-less random fashion). Many advantages, applications, features, components, systems, sub-systems, et cetera of embodiments of the present invention will be appreciated and all such elements of embodiments of the present invention are within the scope of the present disclosure.

A contingent access right may comprise a right, such as an option, that is associated with an event, where the right matures or expires depending upon a future condition or circumstance. In one embodiment, the contingent access right may comprise a right only. In another embodiment the contingent access right may include both a right and an obligation to conduct a transaction, perform an action, and so on. Thus, in the case that the option matures or the condition is satisfied, the holder of the contingent access right may have both the right and obligation to do something. In yet another embodiment, the option may comprise a right but not an obligation to do something. Contingent access rights may be embodied as contingent event certificates. As may be described and/or appreciated, many embodiments of contingent event certificates are possible. All such embodiments are within the scope of the present disclosure.

Throughout this disclosure the terms “contingent access right” and “contingent event certificate” may be used interchangeably to refer to a contingent access right and/or an embodiment thereof. Throughout this disclosure the phrase “for example” means “for example and without limitation.” Throughout this disclosure the terms “points” and “credits” may be used interchangeably except where it is explicitly stated that this not the case or where it is clear from the context that this is not the case. Generally, any and all examples may be provided for the purpose of illustration and not of limitation.

People often buy tickets on a primary market and resell them on a secondary market. The tickets may represent access rights or other rights with respect to a particular event, venue, activity or the like. Where such rights are generally defined or determined at the time of issuance, such as without being subject to a contingency, they may be referred to herein as “defined rights” or “determined rights.” Contingent event certificates may comprise rights, evidence of rights, rights and obligations, or evidence of rights and obligations to acquire something. The rights may be associated with attending an event, buying tickets, or otherwise acquiring a benefit, wherein the rights are contingent upon a future occurrence, determination, or the like (in some cases referred to herein as “forward rights”). Contingent event certificates and contingent rights are described in detail herein and in the documents appended or incorporated by reference hereto, which may be mentioned hereinafter with reference to FIG. 1. Generally, contingent rights may be first sold in a pre-primary market and then traded or resold in a secondary market. As contingencies are resolved, contingent rights may convert, emerge, mature, vest, et cetera into determined rights, which may be first sold on a primary market and then traded or resold in a secondary market. Embodiments of the present invention provide systems and methods that may be associated with a rights marketplace, which may comprise one or more of a pre-primary market, a primary market, and a secondary market. The methods and systems may facilitate allocating an access right to a potential or contingent live event based at least in part on a credit amount obtained through consumer activities associated with a performer of the potential or contingent live event.

Elements, components, applications, features, systems, methods, aspects, et cetera of embodiments of the present invention are described in detail herein and in documents included herein.

Referring now to FIG. 1, an advertisement or promotion 102 may include any form of advertisement or promotion 102. For example, in one embodiment of the invention, credits from music downloads may be used for promotional programs such as a sponsor program. Rather than access rights being a feature of who gets to the front of the line, or who ends up getting through on the phone at a ticket seller, in accordance with embodiments of the present invention access may be earned, such as through a loyalty program. Thus, in another embodiment, knowing that a skier might arrive based on a weather contingency, a vendor could target advertising for a host of related products and services, even if the skier doesn't end up purchasing the package.

An alternative right/benefit 104 may include a wide range of alternative benefits, such as when users accumulate credits that can be applied toward a purchase of a ticket or entry to the event if it were to be certain.

A contingent event certificate 106 may embody a contingent right and/or contingent obligation that are associated with an access right to a contingent event. For example and without limitation, the contingent event may be a live event (e.g., a concert, a sporting event, and so on), the contingent right and contingent obligation may provide the holder of the contingent event certificate 106 with the right and the obligation to purchase the access right to the contingent event, perhaps only after the contingent event becomes fully defined and is no longer contingent. Thus, a contingent aspect 108 of the contingent event certificate 106 may encompass a team that may or not appear in a future collegiate bowl game (or any other game, for that matter); a performer that may or may not perform on a particular date and/or in a particular city, venue, or the like; a weather condition that may or may not materialize; or any other future event or determination that is presently uncertain. With that said, it will be appreciated that some time may elapse between the time when the future event or determination becomes certain and the time at which the right and/or obligation of the contingent event certificate 106 are put into force (such as and without limitation by converting the contingent event certificate 106 into a ticket, pass, or any other type of defined access right).

Throughout this disclosure, the terms “contingent event certificate” and “contingent access right” may be used interchangeably except where it is clearly stated or clear by the context that this is not the case. Similarly, the abbreviation “CEC” may refer to the contingent event certificate 106 and/or the contingent access right except where it is clearly stated or clear by the context that CEC refers to one, to the other, or to both.

In an embodiment of the present invention, options or CECs 106 could be made exercisable based only on the presence of a buyer's designated team in the Super Bowl. A contingency may be associated with a player 121. For example, a fan could purchase a right for a ticket to a particular game if that player was to appear in the game. This contingency may be associated with a venue 114, as described in Harmon 6. For example, contingent event ticket certificates for various events may in the future be scheduled to take place at a designated venue 114. A contingency may be associated with a location 118. For example, a band may or may not end up playing a given town (that is, rights may be for a specific music event in a given town). A contingency may be associated with weather 120. For example, vendors may offer the same item to different individuals, depending on different tastes for weather-related goods and services. A ski package could be contingent on the presence of snow, for example. A contingency may be associated with demand 122 for an event. For example, a toy manufacturer may create CECs 106 for several different lines of toys. Based on demand 122 as determined at least by the number of CECs 106 sold on a primary market, the toys may be released in time for the holidays. The toy manufacturer may decide to produce certain toys in different quantities (or not at all) based on the demonstrated demand levels. Alternatively, the toy manufacturer may issue a limited number of CECs 106 for the toys that would entitle and obligate a holder of the CEC 106 to purchase a first production run of the toy. In this way, the holder of a CEC 106 would be assured to be able to purchase the toy at a fixed price if the toy is produced. In addition, the toy manufacturer can size the first production run appropriately to ensure every CEC 106 holder can purchase the toy.

The event aspect 124 of a CEC 106 may, without limitation, be described within or throughout any and all of the documents included herein. The event 124 may be associated with sports 128. Contingent event ticket certificates 106 may be for various events, such as sporting events. In embodiments, sports fans may themselves be allowed to define a market. For example, a fan may want to see Manchester United play the Spanish National team in the new Miami stadium in 2007. Once this new market is created, a plurality of sports fans (that is, consumers) may purchase the initial allotment and/or trade the CECs 106. Alternatively or additionally, the event 124 may be associated with particular contingent combinations associated with sports 128. For example, the participant-event for which an options or futures contract for tickets and/or accommodations may be purchased may be a team-game, team-round, or team-round-game. The event 124 may be associated with music 130. For example, advanced music access rights may be created for any unique, recurring or one-time event where the possibility of the event occurring is not assured. Concerts, festivals, operas and any other type of domestic or international music or entertainment events may be contingent events. The event 124 may be associated with travel 132. For example, a buyer could purchase an option to purchase a vacation package to a Caribbean island, contingent on the absence of any hurricanes in the Atlantic Ocean one week before the date of departure. The event 124 may be associated with a product launch 134. For example, a product designer may have a concept for a new type of home appliance. The product designer may offer CECs 106 that both entitle and obligate the holder to purchase the home appliance. Through promotion of the appliance, demand 122 may be generated based on a description, virtual model, prototype, et cetera of the home appliance. The promotion may include information about the offered CECs 106. The demand 122 resulting from both direct and indirect promotion of the appliance may be assessed by a count of CECs 106 sold on the pre-primary market. The product designer may use the demand measure to establish contingent agreements for production, distribution, sales, advertising, and support of the appliance. Production may commence once demand 122 reaches a minimum level that may be selected to reduce or eliminate the risk of financial failure. While this example is for a home appliance, the product launch could be for any type of product or service such as a movie, a game, a toy, a book, a composition of music, and the like. It will be appreciated that CECs 106 offered through a pre-primary market can be used to assess the viability of any and all new products or service creations.

The certificate 106 aspect of a CEC 106 may, without limitation, be described within or throughout any and all of the documents included herein. The certificate 106 may be associated with forward rights 140. For example, disclosed herein is a system for allowing a remote user to purchase, over a distributed computer network (e.g., the Internet), an option to purchase a ticket, goods or services, or other item that is based on a contingent event. The certificate 106 may be associated with a reward 142. For example, in one embodiment, businesses can reward employees with CECs 106 if a set standard or goal is achieved. It will be appreciated that a certificate 106 may be tradable (or non-tradable) 105, refundable, purchasable, and so on. It will also be appreciated that a certificate may encompass rights, obligations, and/or the like 148. The rights and/or obligations that the certificate 106 encompasses may mature, vest, convert, expire, et cetera. For example and without limitation, the rights and/or obligations may vest as a reward 142 that occurs in response to an occurrence of a predetermined event. The certificate 106 may encompass associated access 144 to something. For example, each contingent event ticket certificate may correspond to a particular seat within a venue 114. In the case of a personal seat license (PSL), a typical PSL grants the licensee the right to purchase season tickets for a particular seat in the venue 114 every season. A contingent access rights exchange provides a mechanism whereby individuals holding inventory in the form of PSLs may post offers to sell some or all of their holdings, such as subject to a contingency. In other embodiments travel or ski packages (travel, hotel, lift tickets, etc) for spring skiing trips may be optioned. The certificate 106 may be associated with a right and obligation 148, as described in Harmon 6. For example, a contingent event ticket certificate 106 may represent the right and obligation to purchase an event ticket at face value for an event that may (or may not) be scheduled in the future. The certificate 106 may be tradable 150. The certificate 106 may be digital 152, as respectively described in Harmon 6 and Harmon 1. For example, in order to facilitate electronic trading of CECs 106, it is preferred that the initial distribution of CECs 106 is performed electronically. The act of physically delivering the inventory to the exchange and from the exchange to the purchaser is not required. Nor are the steps of making and receiving payments. Instead, the ownership records of the inventory records are changed to reflect the new owner, and financial accounts may be charged and credited for purchases and sales accordingly.

Pricing 154 that is associated with a CEC 106 may, without limitation, be described within or throughout any and all of the documents included herein. For example at least one example of this is provided in Harmon 1, where it is noted that the current market rate for CECs 106 may be quickly surmised from the best bid and best offer for a particular zone of a ballpark.

A contingent event certificate (or rights) market 182 may be associated with a platform 158, which may, without limitation, be described within or throughout any and all of the documents included herein. The platform 158 may be associated with a host 160. The platform 158 may be associated with fulfillment 162, which may be electronic (as described hereinabove with reference to a digital 152 certificate 106) or physical.

Participants 100 may comprise providers or suppliers 164, such as and without limitation event producers 168. For example, a merchant supplier may be the party that originally produced or created the particular item being sold. A merchant supplier could be an event promoter, a venue owner, or a sports franchise.

Participants 100 may comprise related/integrated markets 170, which may be described within or throughout any and all of the documents included herein. The markets 170 may comprise a secondary contingent event certificates or rights market 172. For example, in embodiments a neutral third party may centralize market-related data and provide a marketplace where access rights can be liquid. In embodiments the present invention further encompasses an exchange for trading contingent event ticket certificates. In a preferred embodiment of the invention the exchange holds the inventory of items being traded. The items being traded may be intangible items such as CECs 106. The markets 170 may comprise a rights market 174. For example, credits may convert to a ticket or “fall forward” right that is liquid and tradable on the rights market 174. A process for carrying out such a conversion may comprise a step of assigning one or more seats to the holder of the credits, the one or more seats being associated (perhaps intrinsically or inextricably) with the ticket or “full forward” right. Since full rights can be traded, a market could be run well in advance of the anticipated event. The markets 170 may comprise a rights resale market 178, as respectively described in Harmon 6. For example, once a PSL, ticket, or contingent event ticket certificate inventory has been distributed, embodiments of the present invention involve receiving offers to sell and bids to purchase PSLs, event tickets and contingent event ticket certificates. In an embodiment of the invention transactions are settled in real time. In a preferred embodiment of the invention the exchange holds the inventory of items being traded. The items being traded may be intangible items such as event tickets, or simply access rights. The markets 170 may comprise a primary contingent event certificate or right market 182, such as involving a method for trading CECs 106.

The platform 158 may be associated with a user interface 119 for communication with consumers.

A CEC 106 may be combined 188 with one or more other CECs 106 in a contingent event market platform. Combining 188 CECs 106 may facilitate providing access to an event for a plurality of CEC 106 holders. A combination of CECs 106 may facilitate improving the chances that a holder of the combined CECs 106 will remain obligated to exercise one of the CECs 106. CECs 106 may be combined 188 such that a failure of one CEC 106 may be the contingency required for a second CEC 106 to mature.

CECs 106 may be combined 188 such that the holder or holders of the combined CECs 106 may exchange the certificate at a reduced cost. This may be compared to purchasing a single ticket versus purchasing a “group rate” quantity of tickets. The single ticket may be more costly than one of the group rate tickets because the purchaser of the group rate ticket is obligated to purchase a minimum number of tickets. CECs 106 may be combined 188 to form a group that may qualify for a group rate cost. To illustrate this, an exercise cost for a single mature (contingency met) CEC 106 may be $100 whereas a combination of CECs 106 may result in a cost to exercise each CEC 106 in the combination that may be $85. The contingencies for each CEC 106 in the combination may be the same, such that all of the combined CECs 106 mature together.

CECs 106 may be combined to facilitate improving the chances that at least one of the combined CECs 106 will mature and be exercised. This may be beneficial to a holder of combined CECs 106 who wishes to improve the likelihood of attending an event. While the event may be the same for each combined CEC 106, the contingencies may be different. A combination of CECs 106 may cover a plurality of contingencies such that if any of the contingencies is met, the holder may exercise the mature CEC 106. For example, a combination of CECs 106 may cover an event that is contingent upon weather conditions, such as an outdoor concert. The combination may include a CEC 106 that is contingent upon clear weather, another may be contingent on rain, and yet another may be contingent upon snow. The CEC 106 contingent on clear weather may include an open-air lawn seat. The CEC 106 contingent on rain may include a seat in a covered pavilion; and the CEC 106 contingent on snow may include an indoor seat in a heated building. This combination provides a variety of contingencies for one event.

The cost to exercise and/or the number of CECs 106 available for each of the contingency may be different. For example and without limitation, the venue 114 may include X number of indoor seats each with an exercise price of $100, 4X pavilion seats each with an exercise price of $85, and 10X open air lawn seats each with an exercise price of $40.

A combination of CECs 106 may be associated such that the failure to mature of one of the CECs 106 in the combination becomes a contingency for another CEC 106 in the combination to mature. This allows a market maker of CECs 106 for the event to manage the total number of CECs 106 to mature such that this number does not exceed the number of available seats. In our example the combination CEC 106 that is contingent on rain will not mature if the weather is clear, thereby only allowing the CEC 106 contingent on clear weather to mature. The holder of this combination CEC 106 may be obligated to purchase the open-air lawn seat.

An alternative combination of CECs 106 may facilitate a holder of the combination to attend one of two or more contingent events. As an example, a combination of CECs 106 for a Major League baseball playoff game may include a contingency based on the venue 114 in which the game is played. Continuing the example, a contingency for two CECs 106 may be that a team, such as the Mets, participates in the playoff game. The first CEC 106 in the combination may also include a contingency that the game be played in the Mets home stadium, whereas the second CEC 106 in the combination may include a contingency that the game be played in the opponent's home stadium. A similar combination may include a first CEC 106 of the combination on the Mets playing the playoff game at home and the second CEC 106 of the combination may include a contingency that another team (the Yankees) plays in the playoff game at home. This combination may allow a holder to exercise only one of the combined CECs 106. The Yankees playoff game CEC 106 would not mature if the Mets playoff game CEC 106 matures. Many other such examples will be appreciated and all such examples are within the scope of the present disclosure.

An offering related to a CEC 106 may include disclosure of information 190 about the related offer only if the contingency matures. Withholding the information 190 about the related offering may facilitate increased flexibility of the provider of the related offer in fulfilling the related offer for a mature CEC 106. An example includes an offer for hotel accommodations related to a CEC 106. The related offering information 190 available prior to the CEC 106 maturing may be limited to a class of hotel, a geographic area, and the like. Upon maturing, the related offer provider may determine a specific hotel based at least in part on an aspect of an agreement to provide lodging the provider has made with one or more hotels in the class or geographic area.

A related offering may include a secondary contingency that must be met in addition to the CEC 106 contingency. As an example, the CEC 106 contingency may include a seat at a Mets home playoff game. The related offering may include a contingency that depends upon the holder of the mature CEC 106 providing information 190 such as personal information and/or demographics to the related offer provider to receive the related offering.

A CEC 106 may be combined 192 with other rights. The other rights may be associated with the contingent event. The other rights may be related in time with the contingent event. The other rights may facilitate the holder of the mature CEC 106 attending the contingent event. The rights may include one or more of parking privileges, transportation to the venue city, transportation to the venue, transportation to a hotel in the venue city, transportation (such as taxi, trolley, limousine, town car, bus, train, and any other mode of transportation) among two or more locations associated with the venue 114. The rights may include use of venue facilities, admittance to event associated parties, social network events, meet and greet with the participants of the event, and so on. The rights may include goods and services such as items associated with the event. The CEC 106 may be combined with rights related to lodging. For example, a holder of a mature CEC 106 may, in addition to purchasing a seat at the contingent event may also purchase a hotel room near the venue 114 at a predetermined price (such as a discounted price).

The CEC 106 may be combined 192 with other rights such as the right to sell the CEC 106 before or after maturing. The CEC 106 may be combined 192 with rights to purchase other CECs 106 at a predetermined price. For example, a holder of a CEC 106 for a first round NBA playoff game may, if the CEC 106 matures, gain the right to purchase a second round NBA playoff game CEC 106 at a predetermined price. Many other such combinations 192 of a contingent certificate or right with another right will be appreciated and all such examples are within the scope of the present disclosure.

A CEC 106 may obligate the holder to make a purchase at a future time 194, perhaps when the CEC 106 matures. A CEC 106 may mature at a time 194 when the contingency associated with the CEC 106 is met such that it is no longer contingent. In effect, a CEC 106 becomes an event certificate when the contingency is no longer in question. In an example, an event may include a seat at a second round NBA playoff game. The contingency may include a specific team, such as the Boston Celtics, participating in the game. A CEC 106 for this contingent event may be sold or traded anytime up until the event. However, the CEC 106 remains contingent until it is known with absolute certainty that the Boston Celtics will participate in the second round NBA playoff game. At some time 194, it may be determined that the Celtics have satisfied the requirements established by the NBA to participate in the game. Specifically this may include having a regular season and first round playoff win-loss record that is better relative to at least some other teams in the regular season and first round playoffs. When the Celtics have met all the criteria as defined by NBA, the CEC 106 may mature and be known as an event certificate or ticket.

However, the CEC 106 may expire when the Celtics do not win enough regular season games to participate in the playoffs, or if the Celtics are eliminated in the first round of playoffs from further contention, or if the Celtics are eliminated in the second round of playoffs before the event. This last expiring condition may occur if the CEC 106 is for a 4th game in a best of 5 game series and the series is completed in three games.

A CEC 106 may be contingent 108 upon the timing 194 of an event. For example and without limitation, two CECs 106 may be issued as rain checks for a rained out baseball game before the rain date has been set. Both may be contingent 108 upon the timing 194 of the game on the rain date, with one certificate or right maturing if the rain date is set for a day game and the other maturing if the rain date is set for a night game. Similarly, the timing 194 may relate to whether the rain date is a weekday, weekend, holiday, and so forth. Many other such examples of timing 194 will be appreciated and all such examples are within the scope of the present disclosure.

A CEC 106 may be associated with an advertisement 102. The holder of the certificate or right may be entitled to view, receive, produce, transmit, et cetera an advertisement 102 if and when a contingency becomes defined. For example and without limitation, two advertisers may each purchase a contingent right for a television-advertising slot. The first advertiser may be interested in advertising sunglasses when the forecast is for sunny weather. The second advertiser may be interested in advertising goulashes when the forecast is for rainy weather. The advertisers may purchase the contingent rights in advance of the forecast being known for the time of the slot. When the weather forecast becomes known, one of the rights may mature and the other may expire, depending upon forecast and the contingent right. Many other such examples related to advertising 102 will be appreciated and all such examples are within the scope of the present disclosure.

An event 124 associated with a CEC 106 may be an event such as a performance, competition, or other participatory event. The event 124 may alternatively be associated with a publication 101. The event 124 may be associated with the publication 101 of one or more publications. The CEC 106 may be contingent upon a time associated with the publication 101. For example, a CEC 106 may entitle a holder to purchase a copy of a first printing of a publication 101 if the first printing occurs before a date such as a birthday, holiday, end of month, quarter, or year. In this example, a holder of a CEC 106 may be obligated to purchase the first printing of a new book if it is printed by January 1st. In this way, the publisher may be motivated to make the first printing by January 1st knowing that the holders of the CEC 106 for this event 124 will be obligated to purchase the publication 101 at a predetermined price. The holder of the CEC 106 may be willing to acquire this CEC 106 so that they know they have the right (as well as the obligation) to purchase the first printing of the publication 101.

Music 130 and reunions of certain musical groups hold a great attraction for many people. A CEC 106 that could entitle a holder to a copy of the first distribution of a new recording of a reunited musical group may also be popular and generate interest in the reunion. Determining the likelihood that a reunion and recording would be economically viable may be difficult. Proceeding with the reunion and recording may present personal challenges to the band members as well as financial risks to the band, their promoters, recording label, and the like. The musical group and those who may be taking a risk related to the reunion and recording may use CECs 106 as a measure of the reward potential of a reunion and recording. Additionally, the musical group may receive some income from the sale of CECs 106 that may be used to pay for some of the recording related costs before the recording is complete.

A CEC 106 provides a holder with certain rights that may be related to an event 124 associated with the CEC 106. The rights may relate to a future purchase associated with the event 124. The rights, being related to a future event, may not be exercisable until a contingency associated with the event 124 is satisfied. If the contingency is not satisfied, the rights may expire.

The CEC 106 may represent an agreement between the holder of the CEC 106 and a provider of the event 124. Therefore the event provider may also have rights associated with the CEC 106. The event provider may have the right to receive compensation from the holder of a mature CEC 106 in exchange for the ticket, seat, or other good or service to which the holder of the CEC 106 is entitled.

In addition to rights related to a future event, a holder of a CEC 106 may have other rights such as the right to sell or exchange the CEC 106 through a contingent event certificate or right market platform 158 as herein described.

A CEC 106 may facilitate a business rewarding one or more employees if a set standard or goal is achieved. A contingency for a CEC 106 may include achieving the set standard or goal. In this way a business can use a CEC 106 to provide a reward to an employee contingent on the employee or the business achievement.

As an example, a business may provide CECs 106 to a work team of employees, consultants, contractors, officers, and participants of the work team. The CEC 106 may provide the work team a right to a future event contingent on the work team achieving a set standard or goal. The work team may be charged with producing a prototype of a new product. The event may be a night out on the town that is contingent upon the prototype's being produced before a deadline. If the team produces the prototype by the deadline, the CEC 106 may mature such that the CEC 106 would entitle the holder to the night out on the town.

A CEC 106 may include a plurality of associated events. The plurality of associated events may be contingent on an acceptance of an agreement related to the events. The plurality of events may be contingent on a plurality of contingencies. Examples of a CEC 106 including a plurality of associated events includes a sports team season ticket for all home games, a pass to all concerts in a concert tour, a pass to all opening nights at an opera house for a season, and the like. The plurality of events may include certain terms that a holder of a CEC 106 must agree with before the holder may redeem a mature CEC 106. Such a term may include a ban on smoking at the event venue.

A CEC 106 that may include a plurality of associated events may be split up by a holder of the CEC 106 into subsets of the associated events such as individual events. Such a split may facilitate the holder of the CEC 106 for a plurality of events to sell or exchange one or more CECs 106 for the subset of events. However, a CEC 106 for a plurality of events may be restricted from being split thereby obligating the holder or holders to exchange the CEC 106 for the plurality of events as a whole.

A plurality of events for a CEC 106 may be contingent on a plurality of events. As an example, a plurality of events may include a seat at each home playoff game of a sports team. The plurality of events is contingent on the team reaching the playoffs and then continuing to win in the playoffs such that further home game may be played. If the team does not make the playoffs, the CEC 106 for the plurality of home playoff games expires. Likewise if the team fails to advance beyond the first home playoff game, the CEC 106 would expire.

A CEC 106 may be tradable such as through exchange or sale on a contingent event certificate or right platform 158, or by exchange with the event producer or event ticket provider for another event. However, a CEC 106 may be non-tradable 105. A non-tradable CEC 106 may not be exchanged with an event producer or event ticket provider for another event.

As an example, a CEC 106 for a future event may occur at a time when a holder of the CEC 106 is traveling out of the country and cannot attend the event. The holder may wish to exchange the certificate for another event they can attend. However, the certificate may obligate the holder to make a purchase associated with the event, and therefore the event producer may not accept the CEC 106 in trade for another event ticket or CEC 106. Yet the holder of the CEC 106 may sell or exchange the CEC 106 through the CEC 106 platform, effectively transferring the purchase obligation to a new holder.

A CEC 106 may include security features 109 and may provide a secure form of agreement between the holder and the event producer. To ensure an agreement between a holder of a CEC 106 and event producer is secure, a CEC 106 platform facilitator may require a potential buyer or holder of a CEC 106 to provide critical information such as credit cards and the like to secure the holder's obligation to make a purchase if the CEC 106 matures.

The contingent event certificate or right platform 158, and the CEC 106 itself may be secure and protected from malicious intent of others. The CEC 106 may include a serial number that is associated with the holder of the CEC 106 such that only the holder of the CEC 106 may authorize sale, exchange, or redemption of the CEC 106.

Sports fans, music fans, NASCAR fans, and fans in general often collect and/or trade memorabilia. A CEC 106 may be associated with such a memorabilia. A CEC 106 may be provided to a holder in a collectible 111 format such as a framed certificate. In this way, even an expired CEC 106 may be collectible 111.

A CEC 106 may include a collectible item. A CEC 106 for a collectible item may include a contingency associated with the collectible item. For example, a CEC 106 for a collectible item may entitle a holder of the CEC 106 to an autographed photograph of New England Patriots quarterback Tom Brady if the Patriots win the National Football League title game. In this example, the collectible item is the autographed photograph, and the contingency is the Patriots winning the title game.

Advertisers 113 may be associated with CECs 106. Advertisers 113 may be associated with an event of a CEC 106. Advertisers 113 may be associated with a contingent event certificate or right platform 158. Advertisers 113 may be associated with the sale, exchange, and redemption of a CEC 106. Advertisers 113 may provide a producer of a CEC 106 with compensation to be associated with the CEC 106. For example, an advertiser of bicycling equipment may pay a producer of a CEC 106 for attendance to the Tour de France to allow the advertiser to promote bicycling equipment in association with the CEC 106. This may come in the form of an internet ad campaign, advertisements 102 on a website of the contingent event certificate or right platform 158, print or other media indicating a sponsorship or promotion of the CEC 106.

Advertisers 113 may also provide promotions to holders of CECs 106. An advertiser may, through coordination with a contingent event certificate or right platform 158 facilitator, gain access to a list of holders of CECs 106 and may offer a promotion to the holders that may be associated with the event. For example, an advertiser of tennis equipment may promote a tennis racket with custom markings associated with a tennis event to holders of CECs 106 for the tennis event. Since the holders of the CEC 106 may already have a strong interest in the tennis event (and therefore may know about tennis), they may be more likely to respond positively to such an offer.

Event producers 168 may be associated with CECs 106. Event producers 168 may include merchant suppliers who may have originally produced or created the particular item or event associated with the CEC 106. An event producer 168 associated with a CEC 106 may include an entity, individual, or group who may hold rights related to the event. Such an example includes an investor in the event, a participant in the event, an owner of the venue 114, an owner of the participating team 110, and the like. A publisher may be an event producer 168 for an event related to publishing such as a release of a new book. In addition to sports participants, musicians, artists, and others may also be associated with a CEC 106. An artist may receive a base portion of sales of CECs 106 for an event that they are participating in. In addition the artist may receive other compensation based upon a contingency such as the number of CECs 106 sold or the average sale price of a CEC 106 in a predetermined period of time.

Suppliers 164 associated with a CEC 106 may include manufacturers. Suppliers 164 of product launches 134 may be associated with a CEC 106. A manufacturer may accept an obligation to deliver a product by a predetermined date and may receive a CEC 106 that is contingent on them fulfilling the obligation. In an example, a manufacturer may commit to producing 100,000 new games by October 15 to ensure they are available in retail outlets in time for holiday purchases. In exchange for this commitment, the manufacturer may receive a CEC 106 that may allow the holder to receive a portion of sales revenue for the new game. If the manufacturer meets the production commitment, the certificate may mature and the manufacturer may receive the portion of sales revenue. If the manufacturer does not meet the production commitment, the certificate may expire.

A market for a CEC 106 may be related to or integrated 170 with other markets such as financing markets 115. Related or integrated markets 170 may facilitate securing the underlying interest or security on which the CEC 106 value is initially established. If a CEC 106 is for a sporting event, such as a college bowl football game, a related financing market 115 may be established to purchase (or guarantee to purchase) a plurality of event tickets.

A related or integrated financing market 115 may provide a means for individuals, entities, and the like to participate in the open market sale and exchange of CECs 106 without requiring a purchase or exchange of a CEC 106. Participation in a related or integrated financing market 115 may allow a financing expert to identify a financing model that provides the level of security with upside potential that may facilitate receiving the necessary financial backing to establish the market for the CECs 106.

Financing sources for such a related or integrated market include venture capital, traditional banking, third party private lending, and any combination of these and other financing sources that may facilitate reducing risk to any of the combined financing sources. Venture capital may be a source of financing for establishing and maintaining the CEC 106 platform. Venture capital may also be a source of financing for continual financing event purchases to enable the establishment of the market. Traditional banking may also be included as a financing source in a related or integrated financing market. Traditional banks offer short term and long term interest rates to customers. Typically a short term investment produces a slightly higher interest rate than a long term investment. Financing associated with a CEC 106 may facilitate a traditional bank offering customers a short term base interest rate and a variable rate based on the value of CECs 106 held by the bank.

A bank may offer its customers a CEC 106 for doing something such as signing up for on-line bill payment for example.

Finances to purchase or guarantee purchase of a plurality of one or more items associated with an event (such as a ticket, a meal, a hotel room, and the like) may be provided by a variety of financing vehicles. These financing vehicles may include debt instruments such as loans, convertible securities that may have one or more conversion terms, revenue sharing agreements, and other vehicles as may be used to provide an investor a way of providing financing.

A convertible security may include providing financing in exchange for one or more options by which the inventor providing the financing is to be reimbursed. A conversion option may include converting at least a portion of the security to an ownership in the event, the CEC 106 platform, or the like. In an example, a holder of a convertible security may exchange repayment for the current event for a repayment of a future event. This convertible security may allow a holder of the security to continue to defer repayment. An objective of such a conversion option may be to allow the CEC 106 platform to continue to make purchases and issue new CECs 106 with the potential of the holder of the convertible security to earn even greater return on their initial investment. The conversion option may facilitate converting at least a portion of current repayment to future repayment.

Financing vehicles may also be combined in contingent event certificate or right related/integrated markets 182,170. A combination of vehicles may facilitate reducing a financial risk associated with the market for CECs 106. In an example, a debt instrument, providing repayment on a schedule at a fixed rate of interest may include a risk of default independent of the success of the CEC 106 offering. However, by combining a dept instrument with a revenue sharing agreement, a lender of a debt instrument may receive some portion of revenue of the CEC 106 offering which may mitigate the default risk.

A project financing market 115 related to a CEC 106 may be event based. Aspects of the financing market 115 may be dependent at least in part on the type of event. An event that may be cancelled, such as an outdoor concert, may impact a financing market differently than an event such as a sports championship. The differences between these two types of events may be reflected in the level of risk, and therefore the required reimbursement terms, of a related financing market for the event. In an example, a concert by a single performer, such as Britney Spears, may have a measurable risk of being cancelled. A single performer may get sick, or may be delayed in travel, or may have personal problems that keep her from performing on any given night. Such an event has a quantifiable risk of being cancelled. This risk may be factored into the terms an investor may require for investing in a CEC 106 offering for the event and the investor may expect higher interests, a greater portion of revenue, and/or revenue from other of the performer's events.

A group event, such as a sports championship is unlikely to be cancelled, especially due to one person's physical or emotional health. In such an event, a financing market 115 may have different terms such as lower interest rate but higher revenue sharing as the chance of cancellation is nearly zero. Other events, such as tournaments, TV productions, theatre productions, movie premieres may have risks associated with the event but may be unlikely to be cancelled. A movie premiere may go on even if the star of the movie is not available to attend the premiere. While this risk may be factored in, and one or more CECs 106 may include this as a contingency, the financing market 115 may be impacted differently.

Financing markets 115 for season based CECs 106 (CECs 106 for a plurality of associated events), may include financing to holders of mature CECs 106. Perhaps due to the typically larger cost of a season ticket compared to a single event ticket, a financing market 115 may be established in which the holders may borrow money to purchase the season tickets when the CEC 106 matures. The financing market 115 may include paying the venue producer for the season ticket and receiving reimbursement from the holder of the mature CEC 106 through a debt instrument or the like.

In an example of a season based CEC 106, a mature CEC 106 may entitle (and obligate) the holder to purchase a season ticket to the Boston Symphony Orchestra (“BSO”) 2005-06 performance season. A financing market 115 for a season based CEC 106 may include a lender purchasing the season ticket and providing a ticket to individual BSO performances when the holder has made sufficient payment to the lender. If the holder does not make sufficient payment to the lender, the lender may do as they see fit with the ticket.

A project financing market 115 may be associated with a CEC 106 and may be based at least in part on an aspect of a seat at the event. An aspect of the seat may include a seat license, a season ticket for the seat, or a seating block related to the seat. The seat may be a single seat or a plurality of seats such as a block of seats (e.g. section 101 of the TD BankNorth Garden). A CEC 106 may include an obligation to license a seat associated with a venue 114 of the event.

A seat license may be financed through a secondary market that may include promoters, business entities, and others desiring a financial interest in the seat license. In an example, a CEC 106 may provide a holder with access to a seat that requires a license to use the seat and amenities such as parking passes, private entrance, lounge areas and the like. A seat license may also allow the licensee to have first right of refusal for a ticket for the licensed seat to all of the events held at the venue. A financing arrangement may include providing financing for the seat license in exchange for access to at least some portion of the events held at the venue. The holder of a CEC 106 that includes a seat license may agree to allow a financier of the seat license to have access to one-half of the tickets available to the holder.

A project financing market 115 associated with a CEC 106 may facilitate providing financing based at least in part on a venue 114 for the event. Venues 114 that may be associated with a project financing market 115 may include sports stadiums (e.g. baseball, basketball, football, soccer, rugby, and the like), golf courses, tennis stadiums, ski slopes, Olympic venues, race track (auto, dog, horse), arena, field, pitch, concert hall, theatre, lecture hall. Owners, mortgage holders, investors, and the like of one or more of these venues 114 may participate in a project financing market 115 to facilitate selling out events held at the venue 114. Such entities may wish to provide financing to one or more CEC 106 offerings to increase the probability that the amount of revenue they receive associated with the venue 114 may include sources other than ticket sales.

Referring to FIG. 2, depicting a performer credit program 200, embodiments of the present invention also relates to methods and systems for allocating and/or acquiring an access right, such as a contingent access right 106 to a potential live event 124, such as a contingent or potential live event 124 based at least in part on a credit amount obtained through consumer activities 212 associated with an artist associated with the potential live event 124, such as a performer 214 of the potential live event 124. Consumer activities 212 associated with the performer 214 of the potential live event 124 may include the purchase of performer-related items, such as CD's, apparel, jewelry, decor, gift, stationary, food, beverage, artwork, poster, print, merchandise, memorabilia, book, digital video, DVD, VHS, digital music, and the like, or sports-related items, such as team branded apparel, league branded apparel, team branded merchandise, league branded merchandise, team branded home decor, league branded home decor, team branded furniture, league branded furniture, a team branded automotive accessory, a league branded automotive accessory, a game ball, sports equipment, a hat, a collectible, a baseball cards, sports memorabilia, a video game, a book, a DVD, a VHS, a digital video, and the like. Consumer activities 212 associated with the performer 214 of the potential live event 124 may also include non-commercial activities such as posting on blogs or message boards, joining a loyalty or fan club, supporting the performer's causes, posting the performer's link on a social networking site, referring other fans to purchase performer products or engage in a promotional activity, other performer branding or promotional activities, and the like. For each activity 212, a performer credit amount may be earned and accumulated by the consumer 208 into a performer credit account 210. A fee may be assessed to perform actions, such as and without limitation create, maintain, modify, access, transfer, and the like, with the performer credit account 210. To facilitate fans loyal to the performer 214 having a preferred opportunity to attend the performer's potential live event 124, access rights 106 to the performer's potential live event 124 may be allocated, at least in part, based on accumulated performer credits. In this way, consumers 208 with accumulated performer credits may exchange them for access rights to the potential live event 124. A performer credit account facility 202 may facilitate this exchange. This performer-credit-based access right 106 may make it easier for loyal fans to obtain access to popular events. Such performer-credit-based access rights 106 may be contingent access rights 106, determined rights, defined rights, forward rights, full rights, and any other rights as herein described. A fee may be assessed to create or issue performer-credit-based access rights 106. Performer-credit-based access rights 106 may be created for any unique, recurring, or one-time event where the possibility of the event occurring is not assured as well as for events whose occurrence is certain. Also, such an event may be a contingent event 124 as herein described. The types of potential live events 124 that may benefit from performer credit based access rights allocation may include, but are not limited to: sports events, team events, league events, performances, concerts, festivals, operas, theatre events, or other types of music or entertainment events, including new music releases, opportunities for consumers 208 to interact with performers 214 (e.g., speak with them or the like), or some other event or activity related to an event (e.g., access backstage areas, access pre-event parties, and so on).

Once the performer credits are accumulated, they may be converted to an access right 106 to a potential live event 124, traded, sold, or purchased on a secondary market, used for other performer related transactions, collected, auctioned, donated, gifted, exchanged, won in a contest or lottery, or the like. Performer credits may also obligate a consumer to pay face value for a ticket or provide a specific seat assignment in a venue. In any event, there may be a time limit for performer credit conversion. For example, only performer credits accumulated prior to the formal announcement of a band's touring schedule, and thus during the tour's contingent stage, may be eligible for conversion. Alternatively, credits may still be accumulated after the formal announcement of the tour but perhaps at a reduced rate or value, e.g., one half or one quarter of the pre-announcement rate or value. Thus, rather than access rights being based primarily on who gets to the front of the line, or who ends up getting through on the phone to the ticket dealer, access rights may be earned by supporting a performer or in the alternative an artist or event participant) through the purchase of the performer's music and music-related products as herein described. Live event access thus becomes less a function of random factors and more closely related to a consumer's support of that performer—i.e., a measure of fan loyalty.

A user interface may provide a consumer with a depiction of the best possible seat at a future live event that a consumer could secure if he were instantly to convert his credits to a ticket for that seat. In embodiments, the consumer's accumulation of credits may exceed a threshold and yet he may not instantly be able to convert his credits to a ticket. For example and without limitation, it is possible that the tickets are not yet on sale. In this mode, the user interface may provide the consumer with an incentive to accumulate more credits so as to maintain and/or improve his seat relative to other consumers, some of whom may also be accumulating more credits. In some embodiments, one set of tickets may be on sale while another set of tickets is not. For example and without limitation, in a seating section containing 10 rows the back 3 rows may go on sale first. This may allow those consumers who are happy to just get seats in the section to purchase tickets to those seats. Meanwhile, those consumers who would rather continue accumulating credits in an effort to further improve their possible seats may do so. It will be appreciated that the user interface may be provided in real-time, in a delayed manner, on a website, as a software application's user interface, and so on.

It will be appreciated that embodiments of the present invention provide consumers with direct control over where they may be able to sit in a venue for a live event. This direct control stems from the consumers' ability to accumulate and convert credits, wherein the quality of item to which the credits convert may depend upon the relative quantity of one user's credits as compared with the credits of one or more other users. In other words, embodiments of the present invention provide “user-generated seating assignments,” “community-generated seating assignments,” “user-controlled seating assignments,” and the like.

From time to time, a consumer may designate how many tickets he wants to a future live event and which seats he would like at those events. In the preferred embodiment, the consumer may do this when he registers with a system for receiving credits, before he receives credits, after he receives credits, or at any and all other times.

In one embodiment of the present invention, a consumer 208 may enter a location in which music may be purchased, such as an Internet site like Apple iTunes, a performer's web site such as www.coldplay.com, a retail music CD store, or some other location in which music may be purchased. The consumer 208 may select music to purchase, such as a $0.99 iTunes song, a $16.99 CD, and so on. During the transaction, the consumer 208 may be asked if he would like to have the music purchase applied as performer credits for the performer whose product(s) the consumer 208 purchased. If the consumer 208 chooses to accumulate performer credits, he may register using a consumer user interface 204 of a predetermined website, accept by marking a designated box on an application at the point of sale, fill out a paper form, or use some other registration procedure to enroll in the credit program 200. Registration may create an account 210 in which a consumer 208 may accumulate performer credits. The account 210 may be protected by a username and password and made available to the consumer 208 on a secured website where the consumer 208 may track various credit accumulations for different performers, events, and the like. A predetermined performer credit amount may be associated with the purchase of each type of product a performer has available. For example, a download of a Rolling Stones song on iTunes may entitle the consumer 208 to one Rolling Stones Credit, which may be saved for possible future conversion to an access right to a potential live event 124 involving the Rolling Stones. The number of performer credits associated with a purchase may also factor in characteristics of the content that is the subject of the purchase. For example and without limitation, a newly released Rolling Stones song may be accorded a greater number of performer credits than an older Rolling Stones song; purchase of an entire album or CD may be accorded a greater number of performer credits than purchasing the same number of songs one at a time; and so on. Generally, the number of performer credits that are associated with a particular purchase may be set according to an automatic process, a manual process, or any other process. Such a process may be directed at setting the number of credits in a way that provides a desired marketing or promotional effect. In embodiments, this effect may be directed at providing consumers 208 an incentive to purchase greater quantities of music, to purchase related kinds of music, to purchase unrelated kinds of music that nevertheless may be of interest to the consumer 208, and so on.

In another embodiment, a consumer 208 may enter a Major League Baseball authorized merchandiser. The consumer 208 may select to purchase a hooded sweatshirt emblazoned with the Boston Red Sox logo. During the transaction, the consumer 208 may be asked if she would like to have the merchandise purchase applied as performer credits for the performer whose product(s) the consumer 208 purchased. The consumer 208 may register as described above. A predetermined performer credit amount may be associated with the purchase of each type of product a performer has available. For example, purchase of a Boston Red Sox hat may entitle a consumer 208 to one performer credit whereas purchase of a baseball bat signed by David Ortiz may entitle a consumer 208 to ten performer credits. Generally, the number of performer credits that are associated with a particular purchase may be set according to an automatic process, a manual process, or any other process. Such a process may be directed at setting the number of credits in a way that provides a desired marketing or promotional effect. In embodiments, this effect may be directed at providing consumers 208 an incentive to purchase greater quantities of merchandise, to purchase related kinds of merchandise, to purchase unrelated kinds of merchandise that nevertheless may be of interest to the consumer 208, and so on. Merchandisers may share revenue from purchases made by consumers 208. For example and without limitation, a merchandiser and a neutral arbiter 220 may partner to offer merchandise that may earn a consumer 208 a greater amount of performer credits than usual if purchased during a specified period of time. The neutral arbiter 220 may earn a percentage of the revenue from sales of merchandise to consumers 208 during the specified period of time. Having thus accumulated credits, the consumers may, for example and without limitation, convert the credits to Red Sox tickets; seat assignments; or the like when the tickets first go on sale in the Spring.

The performer credits that a consumer 208 accumulates from purchasing a performer's products may be fractional access rights to a potential live event 124 that may, but is not guaranteed, to occur. For example, the Rolling Stones may have a potential live event 124 that is a live concert performance in Munich, Germany. Consumers may indicate a preference for converting Rolling Stones Credits to an access right(s) to this potential live event 124, and may indicate the number of Rolling Stones Credits of their total Rolling Stones Credit balance that they wish to set aside for conversion to an access right(s) to this event. However, the Rolling Stones may ultimately not tour in Germany and, thus, the potential live event 124 may not occur. Upon the non-occurrence of the event, the Rolling Stones Credits set aside by consumers for the event may be returned to/remain in their Rolling Stones Credit account 210. Alternatively, the consumers who had set aside Rolling Stones Credits for the Munich event may be provided a Rolling Stones Credit bonus in addition to the return of the original amount of Rolling Stones Credits set aside for the event. In another example, the Boston Red Sox may have a potential live event 124 that is a post-season game. Consumers may indicate a preference for converting Boston Red Sox Credits to an access right(s) to this potential live event 124, and may indicate the number of Boston Red Sox Credits of their total Boston Red Sox Credit balance that they wish to set aside for conversion to an access right(s) to this event. However, the Boston Red Sox may ultimately not participate in the post-season and, thus, the potential live event 124 may not occur. Upon the non-occurrence of the event, the Boston Red Sox Credits set aside by consumers for the event may be returned to their Boston Red Sox Credit account 210. Alternatively, the consumers who had set aside Boston Red Sox Credits for the post-season event may be provided a Boston Red Sox Credit bonus in addition to the return of the original amount of Boston Red Sox Credits set aside for the event. This may foster fan loyalty, and serve as an incentive for participation in the program and for signing up for conversion of performer credits for potential live events 124.

Performer credits may also be used for other purposes. For example, a consumer 208 with insufficient performer credits to obtain an access right 106 to an event may sell, transfer, or trade her credits to another consumer 208 who needs additional performer credits to earn an access right 106 to an event (i.e., aggregate sufficient credits to obtain an access right). A fee may be assessed for any transaction related to performer credits, such as selling, transferring, and trading credits. In another example, the performer credits may remain dormant in a consumer's account 210 until the necessary performer credits are accumulated for conversion to an access right 106 to an event. In this example, once the performer credits convert to an access right 106 they remain liquid and may be sold as an access right 106 to an event, and not just an accumulation of performer credits.

An aspect of the present invention may comprise a secondary market for trading and selling performer credits, or credits converted to access rights, may develop in advance of the potential live event 124. For example, a consumer 208 may trade his Rage Against the Machine credits for another consumer's Killers credits, where the value of the credits may not be equal. For example, four Rage Against the Machine credits may equal a single Killers credit. Access rights may be contingent on the potential live event 124 actually occurring, and for this reason may have volatility that attracts speculative bidding for performer credits that may be used to acquire the access rights. Alternatively, performer credits that have been converted to access rights to a potential live event 124 may be traded or sold as a contingent right or “forward” just as other contingent “forward” rights are traded and sold as herein described. For example, a consumer may accumulate 5,000 Norah Jones performer credits in a performer credit account 210 where the amount of performer credits may be sufficient to earn her a CEC 106 to a potential live event 124 featuring Norah Jones. The consumer 208 may trade the Norah Jones performer credits for other performer credits or CECs 106 on a secondary market. The consumer 208 may sell all or a portion of the Norah Jones performer credits on a secondary market. The consumer 208 may buy all or a portion of the Norah Jones performer credits on a secondary market. The consumer 208 may convert the Norah Jones performer credits to a CEC 106 for the potential live event 124 featuring Norah Jones. The consumer 208 may choose to sell the CEC 106 on a secondary market or keep it and exercise the associated rights should the contingency be met for converting the potential live event 124 featuring Norah Jones to an actual event. Trading or selling in the secondary market for performer credits or access rights to potential live events 124 may take place on a website having a user interface designed for this purpose.

Trading in performer credits may be associated with a transaction fee that is similar, in part, to the transaction fee associated with an online equities brokerage account transaction. This transaction fee may be assessed and collected by the performer credit account facility 202. Such a fee may be owned wholly or in part by the performer whose performer credits are the subject of the trade. The potential revenue stream generated by transaction fees may serve as an incentive for performers to participate in the performer credit program 200. For example, a potential live event 124 may be for Cold Play to play a concert in Madison Square Garden. As described in greater detail below, in advance of the event, access rights to the venue seating for the event may be allocated on the basis of Cold Play performer credits. A consumer 208 with sufficient Cold Play performer credits to currently have an access right to one seat for the event may place the performer credits representing an access right to the potential Cold Play Madison Square Garden concert within a secondary market where competitive bidding for the represented access right occurs. Initially, the speculative nature of Cold Play actually playing Madison Square Garden may result in a low bid offers. However, once Cold Play announces it will tour, the offers may go up. Once Cold Play announces that the tour will include North America, the offers may go up further, and so forth. Each time the performer credits representing an access right are traded, Cold Play, or some other entity, may earn the full transaction fee, or some portion thereof.

The potential to be compensated for performer credits or converted access rights 106 in the secondary market may provide an additional incentive for consumers 208 to participate in the performer credit program 200, and may also provide consumers 208 with an additional incentive to make the music-related purchases 212 from which the performer credits are earned. The presence of the secondary market may also attract speculators who may have little or no interest in attending the event, but are trading in the access rights as an investment. This infusion of non-fan consumers 208 into the secondary marketplace may be associated with increased numbers of transactions and related fees that, if shared or owned by performers, may increase performer revenues. Furthermore, the likelihood of the performer credit program 200 increasing the sales of the music-related products of performers who are participants in the credit program 200 may provide an incentive for performers to participate in the credit program 200. In any event, a venue 114 or performer may restrict the performer credits that are eligible for conversion to an access right to only those performer credits obtained through consumer, promotional, or referral activity and not through a secondary market for performer credits. The venue/performer may identify performer credit conversion or use restrictions through a performer user interface 218.

Given the fact that the music industry today uses many points of music distribution, it may be advantageous to provide a facility 202 in which a consumer may accumulate performer credits within a single account 210 from purchases made at multiple locations 212. A consumer's account 210 may be a central repository provided to accumulate performer credits from any of a number of different online and offline sites where music and related products may be purchased. Thus, for example, a single consumer 208 who earns a Cold Play Credit for an iTunes purchase and a Cold Play Credit for buying a Cold Play DVD at a retail location may have both credited to a single account 210. Similarly, a single consumer account 210 may store performer credits for multiple performers. Thus, for example, a consumer 208 purchasing a CD by Cold Play and a CD by Madonna may have both the Cold Play Credit and the Madonna Credit stored in the consumer's single account 210. Alternatively, a single consumer account 210 may store performer credits earned at a single retailer. For example, a consumer 208 may earn U2 credits for a purchase of a U2 album made at Wal-Mart but receive no credit for the same purchase made at iTunes.

In one embodiment of the present invention, performer credits from music related purchases 212 may be used for promotional programs, such as a sponsor program. For example and without limitation, a promotional program could be formed between Sony (the record label) and Cold Play (the band publishing music on the label) to promote newly released songs. Sony may choose to subsidize a greater Cold Play Credit amount for the purchase of those songs sold on the Sony label than the Cold Play Credit amount provided for the purchase of a Cold Play song appearing on another label. This may have the effect of increasing the sales of Sony-labeled Cold Play Songs and, thereby, increasing Sony's Cold Play related revenue.

In one embodiment of the present invention, the allocation of access rights to a performer's potential live event 124 may be based on the number of performer credits accumulated by consumers 208 for that performer from purchases of that performer's products 212. The system may be embodied in a software application that allocates seating in a venue 114 based exclusively on the performer credits accumulated by consumers 208. The software may allocate the seats within a venue 214 (recognizing that some selected seats may be reserved for friends and family of the performers, venue administration, and the like) based at least in part on an algorithm used to derive a performer credit value for each of the venue's 214 seats. For example and without limitation, the seat in the center of the first row may have the highest credit value, whereas the lowest credit value for a venue seat may be placed on the seat in the corner of the last row. The software application used to derive credit values for a venue's seating may collect information regarding the consumers 208 that have indicated an interest in converting performer credits to an access right for that performer's potential live event 124. These customer accounts 210 may then be evaluated to determine the distribution of the performer credit amounts that are held among the customers within the population of customers indicating a desire to convert credits to an access right 106. Each seat in a venue 214 may have a predefined rank that is based at least in part on its imputed level of desirability to live event attendees. The software application may use this imputed level of desirability to develop a rank-order hierarchy that associates the relative number of performer credits in a consumer's account 210 to a particular seat in the venue 214. In this way, the consumer 208 with the highest performer credit rank may be matched to the venue seat with the highest rank. Thus, an access right 106 may be based on a consumer's total performance credit balance for that performer, at that venue 214, relative to other consumers requesting seating at that venue 214. For example, an access right 106 to a potential live event 124 of a very popular performer may require more performer credits for a given venue seat rank than that required for the same seat to access the potential live event 124 of a less popular performer.

Regardless of how the rank is determined, once venue seating rank for a potential live event 124 has been matched to the performer credit rank among consumers 208 indicating a desire to convert performer credits to an access right to the event, users may be informed of the seat corresponding to their current performer credit holdings. This may be communicated to consumers 208 via a software application associated with a website (e.g., the website used by consumers 208 to manage their performer credit accounts 210), by email, ground mail, phone, or some other communications medium or mechanism. In one example, the system may map the credit total corresponding to the venue seat directly onto a seating chart that is distributed to consumers 208. This information may convey to the consumer 208 not only the current seat or block of seats corresponding to his performer credit amount, but also the additional number of performer credits that must be earned in order to improve his seat to a closer row, to a more centrally located seat, to a more desirable seat, and so forth. The information may also be communicated with a closing date on which both the performer credits held in consumer 208 accounts are locked and a final venue seating arrangement matched to the locked performer credit amounts become held by the consumers 208. An awareness of this closing date may provide an incentive for consumers 208 to make additional purchases of the performer's merchandise in order to increase their performer credit rank and, thus, improve their venue seat location. For consumers 208 holding few performer credits, it is possible that all venue seats will be assigned to performer credit ranks higher than their holdings. For these consumers 208, the secondary market may become a valuable means of liquidating credits, as consumers 208 may look to this market to quickly aggregate performer credit amounts sufficient to gain a venue seat allocation or improve their venue seat rank.

Consumers may have the opportunity to designate, in advance, the number of access rights and the preferred location(s) of the potential live event 124 for which they wish to convert performer credits. Consumers may use a consumer user interface 204 to manage performer credit conversion advance designations. In an embodiment, a consumer 208 may designate a weighting factor with respect to quality and quantity of converted access rights 106. For example, a consumer 208 may opt for fewer, higher ranked seats or more, lower ranked seats for the same number of credits. The weighting factor may be used to adjust the ultimate allocation of access rights 106. In another example, if a band ends up playing in a town a consumer may have designated in advance, and the consumer 208 has sufficient performer credits to convert to an access right 106, the consumer 208 may automatically obtain an access right 106 to that venue 114. If the consumer 208 has insufficient performer credits, they may be able to apply their credits in obtaining an access right 106 to another venue 114. However, the consumer 208 may not be eligible for automatic access rights 106 in other venues 114. In addition, the user may designate to convert all performer credit holdings for an access right, or choose to retain some portion of performer credits. A venue 114 or performer may also restrict the performer credits that are eligible for conversion to an access right to only those performer credits obtained in a designated time period, or those obtained on the basis of a particular purchase type (e.g., CD sale), or some other restrictive criterion. The venue/performer may identify performer credit conversion or use restrictions through a performer user interface 218.

In one embodiment, performer credits accumulated from multiple performers may be combined for conversion to an access right for a potential live event 124. For example, for performers with a consumer 208 following, but relatively less mass appeal (e.g., German opera genre performers), it may be possible to group performer credits associated with multiple performers based on genre, language, or other aspect associated with a performer. Similar grouping may be done for performer credits that may be dormant (e.g. a band that is not touring). For example, a neutral arbiter 220 may reach out to consumers 208 with performer credits that are dormant due to the disbandment of a performing group and offer them the ability to secure seats to other performances, such as an upcoming show for an up-and-coming artist from the same record label, a solo performance by a member of that now defunct performing group, and the like. A consumer 208 may select a potential live event 124 of a performer from such a grouping or associated performer list to convert credits to an access right to the potential live event 124. In one embodiment, the consumer 208 electing to use a genre-based credit accumulation, or multiple performer credit accounts to convert to an access right may be matched to a lower venue seat rank than a customer holding the same number of credits from a single performer credit account matching the performer that is the participant in the potential live event 124. The allocation of a lower venue seat rank may be achieved through the use of a weighting factor. In this way, a consumer 208 more devoted to a performer, as evidenced by a greater number of purchases of that performer's products, greater incidence of promotional or branding activity, or greater number of fan referrals, may retain a predominant seat rank over other customers whose devotion to the performer is less, or is allocated across a genre of performers. Consequently, performer credits that directly relate to a performer of a potential live event 124 may demand a premium on a secondary market over genre based performer credits.

In one embodiment of the invention, a neutral arbiter 220, or plurality of neutral arbiters 220, may be employed to aggregate performer credits obtained by consumers 208 across a plurality of purchase locations 212 (e.g., iTunes, URGE, Napster, retail stores) and match performer credit ranks to venue seat ranks for a potential live event 124. In this embodiment, Internet-based download sites, fan club sites, corporate sponsors, and the like may deposit the performer credit data to the neutral arbiter 220. The neutral arbiter 220 may then allocate access rights to venue seating for a potential live event 124 according to predetermined algorithms, such as performer credit ranking and venue seat ranking.

In one embodiment of the invention, a single ticket distributor may contract exclusively with a performer in advance of conversion of accumulated performer credits into access rights to a potential live event 124 or plurality of potential live events 124.

The potential live event 124 may include other events associated with a performer. Such a potential event may be an opportunity to hear and/or purchase performer recordings such as audio files prior to their sale to the general public, to have special access to a performer such as the opportunity to submit a question to a performer or speak with them, to access some other restricted event, and so on. For example and without limitation, a record company may provide an early release of a U2 CD by streaming the music through a website to which access is limited to consumers 208 having a minimum number of U2 performer credits derived from purchases of U2's products. Consumers who have more than this minimum number of U2 performer credits may also be offered participation in a live web chat with fan members about the new CD, a live interaction/event with the band, or some other promotional event. The consumer 208 may have to exchange at least the minimum number of U2 performer credits to access the event. Alternatively, the consumer 208 may not have to exchange the credits. A performer may place restrictions on the credits, such as a cutoff date for the credits being deposited into a performer credit account so that the credits shared or traded after the cutoff date are ineligible for the event. Alternatively, the performer may allow exchange or trading of credits among consumers 208 throughout the event and charge a fee for the exchange or trade. In this way the performer may receive revenue for consumers 208 trading or exchanging credits during the event.

In another example, a level of access to a potential live event 124, independent of seating location, may also be allocated on the basis of consumers' 208 performer credit balances. Access rights to a U2 potential live event 124 may be scaled by access levels such as and without limitation: Level Three Access=right to a venue seat during the event; Level Two Access=right to a venue seat and backstage pass during performance; Level One Access=right to venue seat, backstage pass, and attendance at band's post-performance party.

In one embodiment, the accumulation of performer credits among the consumer 208 fans of a performer may be publicly displayed or advertised. For example, just as high scores for video game performance is listed and updated for online gaming, a website, email notice, ground mail notice, TV announcement, radio announcement, or the like could be used to indicate and track “U2's Biggest Fans” by listing and updating the U2 performer credit totals held in consumer's 208 U2 performer credit accounts 210. This may foster competition, generate additional sales of a performer's products, and gain consumers 208 a level of notoriety that provides a further incentive for them to participate in the program.

Because consumer 208 interest in registering an account 210 for performer credits of a specific performer may be indicative of market demand, this performer-related purchase information comprising types of product and unique performer identifiers may be acquired through the performer user interface 218, compiled in a database, and analyzed as market data to assist a performer's commercial decision making. The database may include indices related to geography, chronology, consumers, and the like. Performer-related purchases may be music-related, sports-related, movie-related, arts-related, and the like. A performer's decision-making may include, but is not limited to, a decision to tour, a decision to tour a specific geographic region, a decision to book a venue type, a decision to book a particular venue size, a decision to play specific or additional dates in a location, and so forth. This market data may also be used to glean information regarding demographic characteristics of a performer's fan-base, to match a performer's products to the types of fans who are most interested in purchasing the products, a performer's popularity, and so forth. The routing and financial risk associated with a touring performer may be minimized, based at least in part on the use of this market data. For example and without limitation, the number of consumers 208 who have accumulated performer credits for a specific band in Chicago and New York City could determine, in part, that the band can sell enough tickets for two shows in Chicago but only one show in New York City. Additionally, music preferences of different locations may be available to assist performer-related contract negotiations, for example, in negotiating how much capital to invest in recording and promoting performers. Market data may also be used to facilitate event planning. The decision to plan a potential event may involve certain criteria. The criteria may include at least one of a range of dates for the event, a geography for the event, a minimum number of performer credits to trigger planning the potential event, a minimum number of consumers to whom performer credits need to be issued in order to trigger planning the potential event, demographics of consumers to whom performer credits have been issued, and the like. Market data may be assessed and compared to the criteria. Relevant market data may include consumer demographics, location of consumer purchase, number of consumer purchases, number of performer credits issued per consumer, total number of performer credits issued, number of consumers who have purchased a performed-related item, and the like. Depending on the outcome of the comparison, an action relating to the potential event may be triggered, such as planning or foregoing the potential event.

Performer credits accumulated by a consumer 208 based on purchases of a specific performer's products, recordings, and other performer related material may be traded for performer credits associated with another performer. This trading aspect of the invention may provide information regarding current trends in music among consumers 208, such as and without limitation a waning interest in one music type among a consumer 208 demographic, and may allow the music industry to analyze market trends. For example, a popular performer may be tracked by how many performer credits are accumulated among consumers 208 and where those consumers 208 are located. Similarly, a performer losing popularity may be tracked according to how many credits for the performer are being traded away by consumers 208, how many credits of a waning performer may be required to acquire a credit of a performer with rising popularity, and where those consumers 208 are located. This information may allow the music industry to focus promotion and marketing of specific performers or performer types on the specific locations with the greatest probability of increasing a performance criterion (e.g., revenue). This market data may be used to determine pricing of a performer's products. Within markets where there is high demand for a performer's products, pricing may be set relatively higher with the expectation that the market will bear this increased expense. Alternatively, the greater market demand in a location may be used, in part, to justify lowering the expense of, and introducing, a great number of a performer's products because the greater sales volume of a greater number of products may still permit revenue targets to be met. This market information may also be used to test market new band products in specific locations and thereby reduce their cost of testing. Performers, or their representatives may use this information in negotiation with venues, recording companies, and the like for all aspects of compensation such as performance fee, accommodations, and the like.

In one embodiment of the present invention, fees may be collected from multiple sources. A ticket distributor or a neutral arbiter 220 may collect a processing fee for allocating and distributing the access rights for a potential live event 124. The consumer 208 converting performer credits for an access right may pay this fee. A second fee may be paid for access to the information collected from the consumers 208 holding accounts 210 within the performer credit program 200. This information may have value to the music industry because it may provide information about potential and current markets for music, concerts, and other performer related merchandise (t-shirts, banners, coffee cups, etc.). A ticket distributor, merchandiser, performer, or performer representative may pay a fee to the exchange for hosting a rights marketplace for a potential live event 124. Alternatively, a ticket distributor, merchandiser, performer or performer representative may share a percentage of product or ticket sales with the exchange. A consumer 208 may be assessed fees to create or issue access rights 106 or perform actions, such as and without limitation create, maintain, modify, access, transfer, and the like, with a performer credit account 210. A consumer 208 may be assessed fees for selling, trading, transferring, buying, converting, or reverting performer credits.

Seat allocation may be based on the relative number of performer credits in consumer performer credit accounts 210. Because seat valuation may be relative to consumer 208 performer credit account balances, an allocation adjustment period may be defined to allow consumers 208 to increase their performer credit account 210 balances to be allocated better seats. In a simplified example of relative value seat allocation, a performer X may have a potential live event 124 for venue Z which has three seats. Each seat may be ranked within a software application by its proximity to the center stage and labeled seat 1, seat 2, and seat 3, where seat 1 is the most highly ranked (i.e., valued). Among all consumers 208 in this simplified example, there are three consumers 208 with a registered account 210 in which there are performer X credits. Each of these consumers has indicated a desire to convert performer X credits to an access right to performer X's potential live event 124. Consumer 1 has 20 performer X credits, consumer 2 has 10, and consumer 3 has 5. Thus, consumer 1 is allocated an access right to seat 1, consumer 2 to seat 2, and consumer 3 to seat 3. For the purposes of this example, it is assumed that the closing date for allocating access rights to the potential live event 124 is two weeks from the initial matching of performer credit rank to venue seat rank. Thus, during the two week allocation period, each consumer has the potential to have his venue seat ranking lowered or raised based upon the purchases of the other consumers. For example, consumer 3 currently is allocated the lowest venue seat rank and trails the holder of the highest venue seat rank (i.e., consumer 1) by 15 performer credits. If consumers 1 and 2 earn no additional performer credits in the remaining two weeks prior to the closing, consumer 3 may gain access to seat 2 by obtaining 6 additional performer credits, or gain access to seat 1 by obtaining 16 more performer credits. Consumer 3 may have the option of obtaining these additional performer credits on the secondary market, or through additional purchases of the performer's products. Alternatively, consumer 3 may lack the ability to increase his performer credit holdings through any means and may be obligated to exercise their access right 106 or may opt out of pursuing the conversion to an access right due, in part, to the low venue seat rank obtained.

Referring again to FIG. 1, a market for a CEC 106 may be associated with a secondary 172 market 170 for a CEC 106. Participants 100 such as financial participants and market participants in a market for CECs 106 may access a secondary contingent event certificate or right market 170 through a user interface 119. The user interface 119 may allow a participant to post CECs 106 on the secondary market for purchase or exchange through a CEC 106 offer screen.

The user interface 119 may also allow a financial participant to monitor postings on the secondary market by viewing a certificate of authenticity of the CEC 106. The user interface 119 may also allow a participant to place a bid for a CEC 106 and perform a transaction such as purchasing the CEC 106 on the secondary market.

A secondary CEC 106 market may include expired CECs 106. A participant user interface to a secondary CEC 106 market may include a listing of CECs 106 available including a status of each CEC 106 (expired, contingent, mature)

A user interface 119 between participants 100 and a project financing market 115 may facilitate a participant 100 determining the financing alternatives associated with the CEC 106 such as those associated with the venue 114, the seat, the event, financing sources, and financing vehicles. In an example, a contingent event certificate or right market participant 100 may use a user interface 119 to view a listing of available financing alternatives and the type of CEC 106 for which they are eligible.

A project financing market user interface 119 may allow a financial participant of a CEC 106 market to view financing offers, compare financing scenarios, distribute request for financing a CEC 106 offering.

A project financing market user interface 119 may facilitate a project financier reviewing and interacting with the current financing of an ongoing CEC 106 offering. The user interface may include controls to facilitate releasing quantities of CECs 106 to the marketplace.

Participants of a CEC 106 market may use a user interface 119 to facilitate viewing seat alternatives that may be associated with a mature CEC 106. The user interface 119 may allow a participant to view a seating chart of a venue 114 and select at least one seat, section, area for purchase of a CEC 106. The user interface 119 may allow a user to select the seat through the contingent event certificate or right market website or through a venue provider's website and be offered a CEC 106 that best fits the selected seat.

A participant 100 of a contingent event certificate or right market 182 may use a user interface 119 to select and or define an assignee to which a CEC 106 would be assigned if the CEC 106 matures. This aspect of a CEC 106 market user interface may facilitate affiliates or brokers 119 who may bid on one or more CECs 106 but assign them to a third party that has made an agreement with the broker or affiliate to purchase the mature CEC 106.

A participant user interface 119 of a contingent event certificate or right market 182 may facilitate access to related websites such as the venue website, the team or teams participating in the contingent or scheduled event 124, and many others that may be related to the event or a sponsor of the event. The user interface 119 may also be used to access and collect data from blogs, message boards, chat forums, fan club or loyalty sites, social networking sites, performer sites, performer-referred sites, referring other fans to purchase performer products or engage in a promotional activity, other performer branding or promotional activities or sites, and the like.

A financial or market participant user interface 119 of a CEC 106 market may facilitate a holder of a contingent certificate making a selection to post a ticket to a rights resale market if the CEC 106 matures. The selection may be made by the participant as a condition of acceptance of the participant's bid. It may be made at the time a bid for the CEC 106 is accepted, or it may be made upon receipt of payment for the ticket.

An advertiser 113 may use a user interface 119 to access the contingent event certificate or right market platform 158. The advertiser 113 may use the user interface 119 to perform a transaction with the platform such as paying for placement of an advertisement 102. The advertiser user interface 119 may also facilitate the advertiser 113 accessing demographics of holders of CECs 106.

Advertisers 113 may also use a user interface 119 to a contingent event certificate or right market platform 158 to review CEC 106 offering sale and exchange performance related statistics. The advertisers 113 may use demographic and CEC 106 offering performance information to provide targeted advertisements 102 to participants of the market.

Event producers 168 may interact with a contingent event certificate or right market platform 158 through a user interface 119. The user interface 119 may facilitate an event producer's 168 releasing allocations of CECs 106 to be sold or exchanged through the market platform 158. In an example, an event producer 168 may choose to manage releases of CECs 106 over time to maintain interest in the event and to provide participants the opportunity to purchase a CEC 106.

The event producers 168 may also use the user interface 119 of the CEC 106 market to identify rules associated with the CECs 106. The event producers 168 may use the user interface 119 to modify, monitor, or review or generate reports on CEC 106 activity such as transaction rates, fees, sale prices, and the like.

Season ticket holders or others closely associated with an event producer 168 may be identified through the event producer user interface 119 such that the platform 158 provides them an offer of a CEC 106 in advance of a public offering of the CECs 106

Event producers 168 may use the user interface 119 to coordinate demand 122 associated with the CEC 106 offering and/or the event. An event producer 168 may identify a threshold, such as threshold of CEC 106 offer transaction activity, and may use the user interface 119 to establish this threshold in the platform 158. The threshold may be associated with a demand 122 for seats. The event producer 168 may use the user interface 119 to receive an alert if the threshold is exceeded. The event producers 168 may then use the user interface 119 to manage one or more aspects of the CEC 106 offering.

Retailers may use the user interface 119 to transmit information regarding merchandise sales, a consumer's performer credit accumulation selections, other consumer activity, and the like.

A participant 100 of a contingent event certificate or right market 182 may associate a CEC 106 he/she is holding with a social network facility 116, which may provide, comprise, encompass, or otherwise be associated with social networking website. A user interface 119 for the social network site may allow a user to enter a link to a listing on the contingent event certificate or right platform 158 of the CEC 106 the user currently has to offer.

A contingent event certificate market platform 158 may be hosted on a computing facility, such as and without limitation a server. The host 160 may be a computer system that provides services to other computing systems and clients over a network, such as a local area network, wide area network, wireless network, intranet, the Internet, or the like. The server may be a computer system that operates continuously on the network and provides full-time access to the contingent event certificate market platform 158. The host 160 may provide a facility for an application server, database server, file server, client-server, or the like. The host 160 may provide hardware and/or software in support of the hosting of the contingent event certificate market platform 158. Host 160 hardware may include a central processing unit; input/output (I/O) facilities, such as keyboards, displays, disk drives, modems, network cards, or the like; memory, such as RAM, ROM, or the like; mass memory, such as optical discs, hard disks, or the like; or other such computer hardware. Host server software may include system software, program software, application software, business software, databases, or the like.

The host 160 may provide software-based services for users of the contingent event certificate market platform 158 that may provide personalized access capabilities, which may be adapted for consumers, event producers, advertisers, social network interfaces, related/integrated markets, or the like. Users may have customized access to host services of the contingent event certificate market platform 158 through a web portal, where access may be dependent upon the type of user, such as a usermame/password customer interface for CEC 106 transactions, a secure access for event producers 168, customer service access for advertisers 113, or the like. The host 160 may provide access to data storage for users of the contingent event certificate market platform 158, such as user information, billing information, event information, contingent conditions, certificate tracking of ownership and price, or the like. The host 160 may also provide facilities for providing tickets or CECs 106 to users, system security, internationalization and technological interface to users, or the like.

The contingent event certificate market platform 158 may provide for a facility to fulfill user orders (fulfillment 162), and send the user a physical document in the form of a CEC 106, event ticket, receipt, voucher, or the like, and to fulfill orders for merchandise, goods, or services, that are purchased by the consumer that is associated with the potential or contingent live event. The document may be printed and physically mailed to a user-specified shipping address, bought at a ticket window or box office, printed at a store by a store employee, printed at a kiosk by the user, or the like. The document may include a facility for identification and authentication of the document by ID number, barcode, magnetic stripe, password, biometrics, or the like. The document may have an element for securing against counterfeiting, such as special paper, treatments to the paper, intricate artwork, holograms, or the like. The contingent event certificate market platform 158 may allow for the transfer of ownership of the CEC 106. Transfer of ownership may be performed on-line, by phone, at a ticket window or box office, at a store, a kiosk, or the like. Transfer of ownership may result in a new CEC 106 identification number being generated, and a new document sent to the new owner. Fulfillment 162 of CEC 106 orders may also take other forms, such as a pass card, a discount pass, a club card, a season pass, or the like. The document may have the facility to add or subtract CEC 106 registrations, interface with a computational facility, scanned for entrance to an event, or the like.

The contingent event certificate market platform 158 host 160 may comprise the facility for storing data. Data may include user information, billing information, event information, contingent conditions, certificate tracking of ownership and price, or the like. Data may be stored local to the contingent event certificate market platform's 182 host 160, such as within the same physical memory space as applications software, operating software, or the like. Data may be stored remote from the contingent event certificate market platform's 182 host 160, such as in a separate memory, separate computer resource, content delivery networks, content distribution networks, or the like. Data stored in the contingent event certificate market platform 158 may be accessible by customers, social networks, advertisers 113, event producers 168, related/integrated markets 170, or the like. Access to data within the contingent event certificate market platform 158 may require authentication, such as a username, password, security code, or the like. Data may also continually change to reflect changing event information, pricing, threshold demand levels, contingent changes, or the like.

The contingent event certificate market platform 158 may provide security against risks associated with computer use. Techniques for reducing risks to computer security associated with the contingent event certificate market platform 158 may include providing backups, anti-virus software, firewalls, access control lists, authorization and authentication software, encryption, intrusion-detection systems, or the like. Backups may be a continuous or scheduled activity within the system, and may provide for the copying of data so that these additional copies may be restored if the originals are damaged or lost. Anti-virus software may include computer programs that attempt to identify, thwart, and eliminate computer viruses and other malicious software. Firewalls may help protect the contingent event certificate market platform 158 from intrusions by restricting network traffic, which may be based on a set of system administrator defined rules. Authorization may restrict access to the contingent event certificate market platform 158 to a group of users, such as customers, event producers, contingent event certificate market platform 158 employees, or the like. Restrictions may be accomplished through the use of authentication systems. The contingent event certificate market platform 158 may employ encryption to protect messages, or intrusion-detection systems that scan the network for unauthorized users and activities.

The contingent event certificate market platform 158 may provide internationalization of user interfaces 119 such as language translation, currency conversion, location-based services, or the like. The contingent event certificate market platform 158 may provide for a user interface 119 that includes access to the system through a plurality of languages, language translations, translator services, or the like. Languages may include English, Spanish, German, French, Portuguese, Italian, Japanese, Russian, Chinese, or the like. The contingent event certificate market platform 158 may provide for a user interface 119 that includes access to currency conversion. Currencies may include the US dollar, Canadian dollar, Euro, Pound, Yen, Ruble, or the like. Currency conversion services may be associated with the currency of the user. For instance, a user that has selected German as their user interface language may cause the contingent event certificate market platform 158 to choose the Euro as the default currency for the exchange, with alternate currencies made available as selected by the user.

The contingent event certificate market platform 158 may provide for location-based services, such as a service based on cell phone location, IP address, user self-entry, internet service provider location, event location, or the like. An example of a location-based service may be a user placing a phone call from a cell phone in Italy for an event located in Italy. The contingent event certificate market platform 158 may set a priority for Italian as the user interface language because of the location of the user and the relevance of an event located in Italy. The contingent event certificate market platform 158 may also provide for alternative languages for the user to choose from, for example, in the instance of an English speaker visiting Italy, and attempting to acquire tickets to a show in Italy as a part of the English speaker's vacation. The contingent event certificate market platform 158 may also provide for a default currency based on an event location, such as the peso being selected as the default currency based on the event's taking place in Mexico City.

The contingent event certificate market platform 158 may be accessed through the Internet from a plurality of sources, such as a computer, PDA, phone, mobile phone, cellular phone, GSM phone, network client device, or the like. The computer may be used to connect to the Internet, for example, using the computer's internet browser the user may connect to the contingent event certificate market platform 158 though the user's internet service provider. The user may also be able to connect to the contingent event certificate market platform 158 through the browser of the user's mobile communications facility, such as through the user's PDA, mobile phone, cellular phone, GSM phone, or other network client device known to the art. For example, a user of a cell phone may use the Internet connectivity of their cell phone to connect to the contingent event certificate market platform 158 through their wireless provider's distributed communications facility and Internet gateway.

The contingent event certificate market platform 158 may be accessed through the telephone system, such as from a phone, a mobile phone, cellular phone, GSM phone or the like. A user may place orders for CECs 106, trade CECs 106, schedule events, arrange for advertisements 102, or the like. Wireless providers may offer customers special access promotions to contingent event certificate's 106 and other products which customers access via cell phones. For example, a wireless provider may provide a discounted service that can only be accessed though their wireless service. Another example may be a wireless provider reserving special access to blocks of reserved tickets.

User interfaces 119 to the contingent event certificate market platform 158 may include and/or be associated with a social network facility 116 (the “social networks”). Social networks may be communities that in some part utilize the Internet as an element of their social organization. Examples of social networks may be MySpace, Friendster, Facebook, Gaia Online, orkut, Piczo, Yahoo! “360,” or the like. Internet social networks may be formed through an initial set of founders who invite members to join their site. New members may repeat the process, growing the total number of members and links in the network. Sites may offer features such as automatic address book updates, viewable profiles, the ability to form new links through introduction services, or other forms of online social connection known to the art. Social networks may also be organized around other connections such as ethnic groups, entertainment media, schools, services, business, age groups, sports, games, travel, technologies, dating, or the like.

Social networks may utilize a blended networking approach that may combine online activities with offline elements, such as face-to-face events. Examples of this blended approach may be MySpace, that associates its online activity to independent music and party gatherings, or Facebook that associates with activity within the college community. Social networks on the Internet may also be focused on specialized activities such as art, tennis, football, soccer, golf, cars, dog owners, or the like. These networks may provide a virtual extension of a groups activities such as sharing photos, video, stories, planning, group rates, or the like. Internet social networks may also provide specialized interfaces to outside activities that are associated with the social network's focus. An example of this may be an Internet social network focused on football that interfaces with sport fan clubs, fantasy football leagues, online sports reviews, ticket suppliers, or the like.

The contingent event certificate market platform 158 may have an interface with Internet social networks, which may be depicted as an association between the social network facility 116 and the platform 158. These social networks may have specialized interfaces with the contingent event certificate market platform or 182 be the result of social interaction within the social network. The interface between the contingent event certificate market platform 158 and the social network may include selection of existing buy and sell options, monitoring of personal buy and sell status, viewing of exiting events, initiation of a CEC 106 for a new event, the initiation of a CEC 106 for a event that has already received other CECs 106 but is not an actual event yet, monitoring of the aggregation of demand 122 for an event, or the like. The interface may be implemented as an exchange between the social network's host servers and the contingent event certificate market 182 platform's 158 host 160 as a special interface between the two networks or a general interface such as with any other customer.

An event taking place may be contingent upon the demand 122 that is aggregated for the event through CEC 106 generation and the threshold for demand 122 set for the event to take place. An individual customer may participate directly in the contingent event certificate or rights market 182. Alternatively, an individual may participate in the market 182 through the interface or association between the social network facility 116 and the contingent event certificate market platform 158. Individuals may have an interface to the contingent event certificate market platform 158 through social networks such as MySpace, Friendster, Facebook, Gaia Online, orkut, Piczo, Yahoo! 360, or the like. For instance, the Internet social network MySpace has online associations to independent music and party gatherings, and may provide an integrated interface to the contingent event certificate market platform 158. A MySpace member may initiate a CEC 106 for a new music concert with a targeted artist and targeted venue 114, and monitor the aggregation of demand 122 for the event. This aggregation of demand 122 may generate interest from an artist who then may set a demand threshold for enabling the event to take place.

The demand aggregation process may be a dynamic interaction between customer demand 122 for a given event, and the event participant's required demand threshold to enable the event to take place. An Internet social network member may generate a CEC 106 for an event that is not yet available, such as a music concert, a meeting of an artist, a match-up between sports teams, a lecture by a famous individual, or the like. Members of the Internet social network may then purchase CECs 106 to the event and thereby aggregate demand 122 for the event. Demand 122 for the event, in the form of CEC 106 purchases, may be communicated to management facilities for relaying to supply event performers. An event performer may in turn set a demand threshold for the event to take place, such as Bob Dylan requiring a demand of 10,000 CECs 106 for a concert at Red Rocks, Colo., or the physicist Stephen Hawking requiring a demand of 2,000 CECs 106 for a lecture at Albert Hall, London, or a 1970's punk rock star requiring 100 CECs 106 to come to a large party to meet the guests, or the like.

Once a CEC 106 is purchased, it may be sold or traded prior to the event becoming fixed. The selling and trading of CECs 106 may be facilitated within the contingent event certificate market platform 158, such as with Fan Forwards™ commodity trading services for event tickets, or within a secondary market place. Fan Forwards™ commodity trading services may be a way of buying and selling CECs 106 within the controlled environment of the contingent event certificate market platform 158. If the demand threshold for an event is met, then the event may take place and purchasers of CECs 106 may be obligated to purchase tickets to the event. If the demand threshold is not met, the holders of the CECs 106 may, or may not, receive refunds for the cost of their CECs 106. The process of aggregation of demand 122 may drive an event from being contemplated, to being scheduled and populated, and finally fixed for ticket sales. Once the event is fixed, CEC 106 holders may be able to purchase tickets to the actual event. If demand 122 does not reach demand threshold, no event may take place. And during the process of demand aggregation, a secondary market place may allow CEC 106 holders to financially profit from the selling of CECs 106.

Event performers may register within the contingent event certificate market platform 158 or be contacted by a management facility in order to be made available for events. Event performers may include musicians, celebrities, lecturers, sports figures, entertainers, or the like. An event performer may specify conditions under which they will perform, such as if a certain minimum amount of money is guaranteed; if the event is in a certain location, date, venue 114; if there is a guaranteed number of performances per year; or the like. The event performer may contractually bind themselves to these specified conditions, and monitor the demand aggregation for their services using the contingent event certificate market platform 158 user interface. The event performer may have the option to accept conditions outside the initially specified conditions. For instance, if the event performer had originally specified New York City as the only location they would be willing to perform in, but monitors the demand 122 and observes a demand 122 for them to perform in different city, they may have the option to accept the new location and enable the performance to take place.

A facility for measuring and tracking the demand 122 for events may be provided within the contingent event certificate market platform 158. The facility may provide for monitoring of demand 122 by individual customers, members of an Internet social network, event performers, event and event performer management facilities, or the like. The user interface may be sorted by genre, such as music concerts, lectures, meet the celebrity, or the like; performers; locations, such as New York City, Boston, London, or the like; date; venue 114; and other like variables to be sorted. Since demand is a function of CECs 106, security measures may also be taken to ensure the validity of each CEC 106, such as supplying digital tags to each CEC 106.

Social networks may provide certain benefits to loyalty clubs of event performers. A fan may enroll in a club and purchase products associated with the event performer, such as music downloads, tee-shirts, mugs, jewelry, or the like, from the club website. The fan may earn loyalty points for each purchase. The loyalty club may offer CEC 106 promotions to fans in possession of a certain number of points, or to the fan with the greatest number of points, where the CEC 106 may be made available for purchase or given freely as a loyalty reward. In turn, the fan in possession of the CEC 106 may sell the CEC 106 within a trading facility within the contingent event certificate market platform 158, in a secondary marketplace, within the loyalty club, or the like.

It will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

While many preferred embodiments of the invention have been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

What is claimed is:

1. A method for acquiring an access right to a live event, comprising: accumulating credits through an activity that is associated with a measure of fan loyalty; determining if an amount of accumulated credits surpasses a threshold for conversion to an access right; and converting the credits to an access right to a live event.
